(19) United States
(12) Patent Application Publication
(10) Pub. No.: US 2018/0235296 A1
(43) Pub. Date: Aug. 23, 2018

(54) Perspiration Shield

(71) Applicants: Theresa Jane Pope, Milton Keynes (GB); Hayley Marie Leete, Northampton (GB)

(72) Inventors: Theresa Jane Pope, Milton Keynes (GB); Hayley Marie Leete, Northampton (GB)

(21) Appl. No.: 15/899,814

(22) Filed: Feb. 20, 2018

(30) Foreign Application Priority Data
Feb. 21, 2017 (GB) 17 02 753.3

(51) Int. Cl. A41D 27/13; B32B 27/40; B32B 3/26; B32B 27/12

(52) U.S. Cl. CPC A41D 27/133; B32B 27/40; B32B 3/26; B32B 27/12; B32B 2307/758; B32B 2307/7265; B32B 2437/00; B32B 2555/00; B32B 2262/04; A41D 2400/62

(57) ABSTRACT

A perspiration shield is disclosed. The perspiration shield is releasably adherable to the skin of an underarm and has an inner side and an outer side. The shield comprises a layer of a perspiration absorbent material, a layer of a perspiration impermeable material, and an adhesive composition suitable for releasably adhering the shield to the skin of a wearer's underarm. The materials are arranged such that the perspiration absorbent material is exposed over at least a portion of the inner side of the shield defining a first area, and the adhesive composition is disposed on the inner side of the shield defining a border circumferential about the first area. A portion of the shield is arranged to extend radially outwardly of the border defining a tab portion to facilitate easier removal of the shield from the wearer's skin following use.

### CROSS REFERENCE TO RELATED APPLICATIONS

This application claims priority from United Kingdom patent application No. 17 02 753.3 filed 21 Feb. 2017, the whole contents of which are incorporated herein by reference in their entirety.

### BACKGROUND OF THE INVENTION

### 1. Field of the Invention

The present invention relates to perspiration shields that are releasably adherable to the skin of an underarm.

### 2. Description of the Related Art

Perspiration shields for releasably adhering to the skin of a wearer's underarm are known. Typically such shields include a perspiration absorbent material, for example cotton fibres, forming an inner, skin facing layer, to absorb perspiration excreted by the underarm sweat gland area. Additionally, it is common for such shields to include a perspiration impermeable outer layer, in order to prevent perspiration absorbed by the absorbent material from leaking onto the wearer's clothing, as might otherwise occur by capillary action of the absorbent material or in the event that the absorbent material were to become saturated.

Typically the known shields include an adhesive composition applied on the inner layer. Often, the adhesive is applied as a border proximal the peripheral edge of the shield generally annular about the perspiration absorbent material, rather than being applied over the entire area of the shield. This disposition of adhesive is often desirable such that the perspiration absorbent material is not contaminated with an adhesive that might reduce its absorbency. Disposition of the adhesive in this way, i.e. applying the adhesive composition over only a relatively small portion of the shield, does however tend to require that the specific bond strength of the adhesive composition is increased.

Difficulties can be encountered however when using adhesive compositions exhibiting relatively high bond strengths, inasmuch that removal of the shield from the skin can become difficult. To facilitate easier removal it is known for the adhesive border to define a ‘break’, i.e. an area to which adhesive is not applied. The break in the adhesive border can usefully allow a wearer to insert a finger underneath the shield in order to obtain purchase on the shield. However, the break can disadvantageously allow perspiration to leach outwardly of the shield through the break, which can result in the perspiration coming into contact with the wearer's clothing.

It is desirable therefore to provide a perspiration shield which obviates the above noted problems that can be encountered with perspiration shields of the prior art. In particular, it is desirable to provide a shield with means for facilitating easy removal of the shield from the skin of a wearer's underarm.

### BRIEF SUMMARY OF THE INVENTION

According to a first aspect of the present invention, there is provided a perspiration shield releasably adherable to the skin of an underarm and having an inner side and an outer side, the shield comprising: a perspiration absorbent material; a perspiration impermeable material; and an adhesive composition suitable for releasably adhering said shield to the skin of an underarm; in which said perspiration absorbent material is exposed over at least a portion of said inner side of said shield defining a first area; and said adhesive composition is disposed on said inner side of said shield defining a border circumferential about said first area; and in which a portion of said shield extends radially outwardly of said border defining a tab portion.

Preferably said adhesive border is substantially uniform in width about its circumference.

Preferably said adhesive border is substantially unbroken about its circumference.

Preferably said tab portion is substantially free of said adhesive composition.

Preferably said border is arranged proximal the peripheral edge of said shield.

Preferably said shield is generally triangular in shape having a base and a vertex.

Preferably said tab portion extends outwardly from adjacent the base of said triangular shaped shield.

Preferably said perspiration absorbent material defines a first layer having an inner side and an outer side and having a perimeter defining a first shape; and in which said perspiration impermeable material defines a second layer having an inner side and an outer side and having a perimeter defining a second shape.

Preferably said first layer is arranged on the inner side of said second layer such that said outer side of said first layer contacts said inner side of said second layer.

Preferably said first and second layers are generally triangular in shape.

Preferably the area of said second layer is relatively greater than the area of said first layer.

Preferably said border is defined between the perimeter of said first layer and the perimeter of said second layer.

Preferably said second layer defines said tab portion.

Preferably said shield is generally acute-isosceles triangular in shape.

Preferably said perspiration impermeable material comprises polyurethane.

Preferably said second layer is fabricated from polyurethane film.

Preferably said perspiration absorbent material comprises viscose fibre.

Preferably said tab portion is integral with said second layer.

Preferably said tab portion is configured to facilitate removal of the shield from the skin of an underarm.

Preferably said tab portion is dimensioned as to conveniently allow a user to obtain sufficient purchase on the tab portion between the thumb and forefinger as to exert a force on the tab portion sufficient to break the adhesive bond between said shield and the skin of an underarm.

### BRIEF DESCRIPTION OF THE DRAWINGS

The invention will now be described by way of example only with reference to the accompanying drawings, which are purely schematic and not to scale, of which:

FIG. 1 shows an exemplary embodiment of a perspiration shield according to the present invention;

FIGS. 2a, 2b, 2c, 2d and 2e show the perspiration shield 101 in inner and outer plan, side and end elevations, and an exploded view respectively;

FIG. 3 shows the perspiration shield in a perspective view; and

FIGS. 4a and 4b show the perspiration shield adhered to the underarm skin of the wearer.

### DETAILED DESCRIPTION OF EXAMPLE EMBODIMENTS

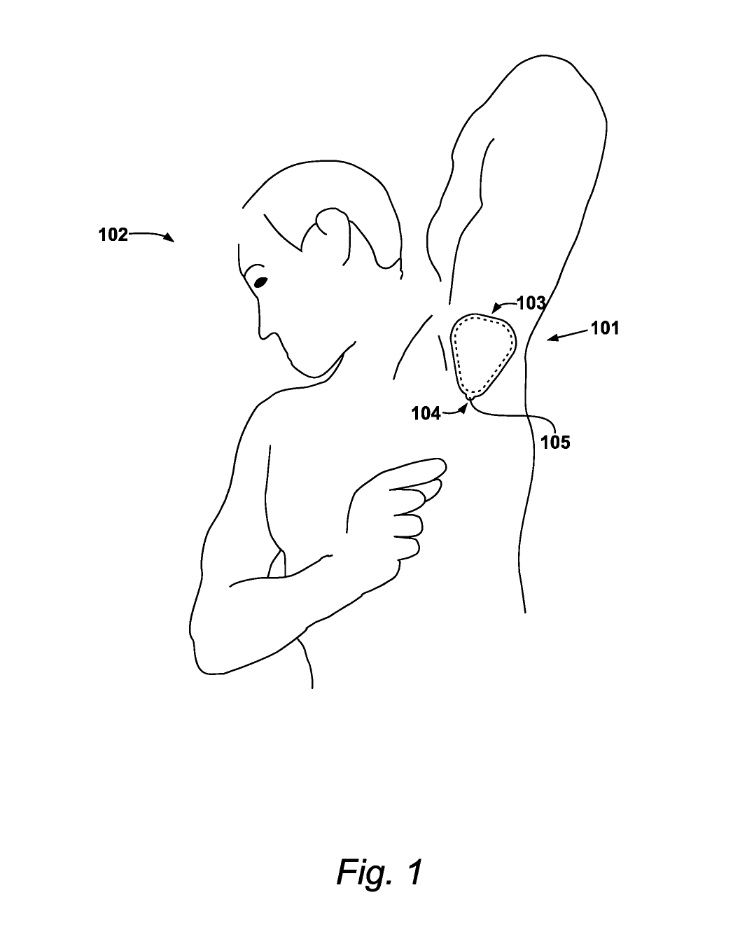

### FIG. 1

An exemplary embodiment of a perspiration shield according to the present invention is illustrated in FIG. 1.

In the Figure, a perspiration shield 101 according to an embodiment of the present invention is shown adhered to the skin of the underarm of the wearer 102. As will be appreciated, the primary function of said perspiration shield 101 is to absorb and contain perspiration excreted by the underarm sweat gland area, so as to prevent the perspiration from coming into contact with the wearer's clothing, and moreover to prevent the release of unpleasant odours produced by bacteria metabolizing chemicals present in the perspiration. The perspiration shield 101 is configured to be releasably adherable to the wearer's underarm skin, in such a way as to allow the wearer to readily adhere or remove the shield from the skin. In the specific embodiment, the shield 101 is configured to be single-use, and thus it is expected that the shield will be adhered to and removed from the skin only once before being discarded.

As illustrated, in the embodiment the shield 101 is generally triangular in shape. More particularly, in the specific embodiment illustrated the shield 101 is generally acute-isosceles triangular in shape. As used herein, the term ‘acute-isosceles triangular’ is intended to define the shield as being generally triangular in shape and having only two sides of generally equal length, and wherein the vertex angle, and indeed all three angles, are acute.

In the embodiment, the shield defines an arm end 103 and a torso end 104. The arm end 103 is relatively wider than the torso end 104. In the particular embodiment, the torso end 104 is defined generally by the vertex of the generally triangular shield, and the arm end 103 is defined generally by the base of the generally triangular shield.

As illustrated, in the specific embodiment said shield 101 is configured for wearing by the wearer in an inverted orientation, i.e. in an orientation wherein the base of the triangular shield is oriented generally towards the arm of the wearer, and the vertex of the shield is oriented generally towards the torso of the wearer.

The particular acute-isosceles triangular shape of the present shield 101 is advantageous as it approximates closely to the average shape of a person's underarm sweat gland area. Moreover, the present applicant is aware that the underarm sweat gland area is usually generally acute-isosceles triangular in shape, with the area being relatively great in width towards the arm, and then tapering in width relatively sharply towards the torso almost to a point. Thus, the inverted orientation of the present shield 101, along with the shape of the shield 101, permits near full coverage of the sweat gland area with a near minimum area of shield material. In this respect, it will be appreciated that it is desirable that the area of the shield 101 is minimised as far as possible, whilst still maintaining an acceptable level of coverage of the sweat gland area, in order that excess material does not reduce the comfort of the shield to the wearer.

Referring to the Figure, said perspiration shield comprises tab portion 105 extending outwardly of the natural periphery of the shield 101. As will be described, the primary function of tab portion 105 is to serve as a ‘handle’ to be gripped by the wearer to conveniently allow a user to break the adhesive bond between the shield and the skin and thus remove the shield 101 from the underarm skin.

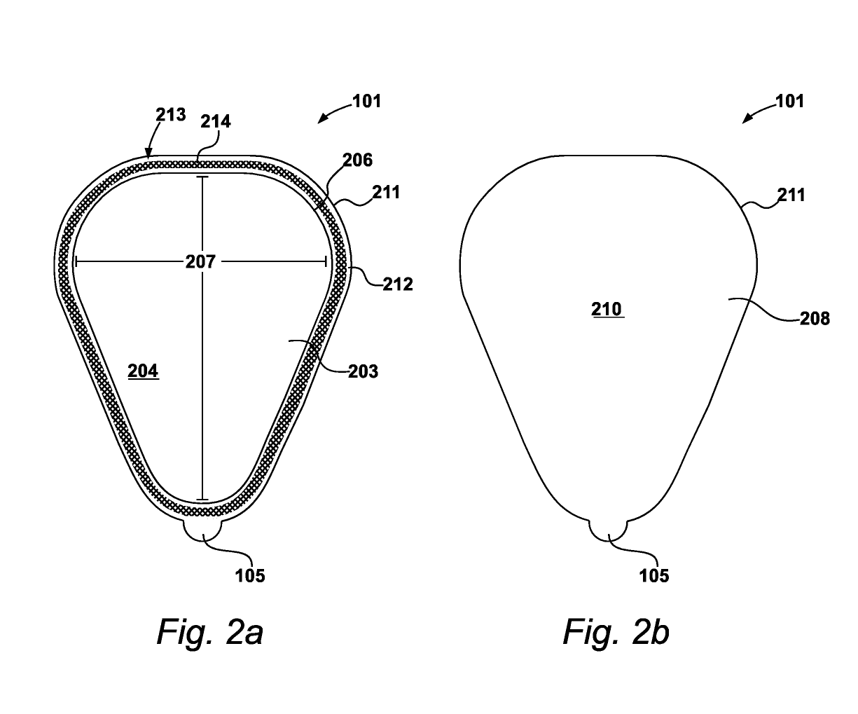

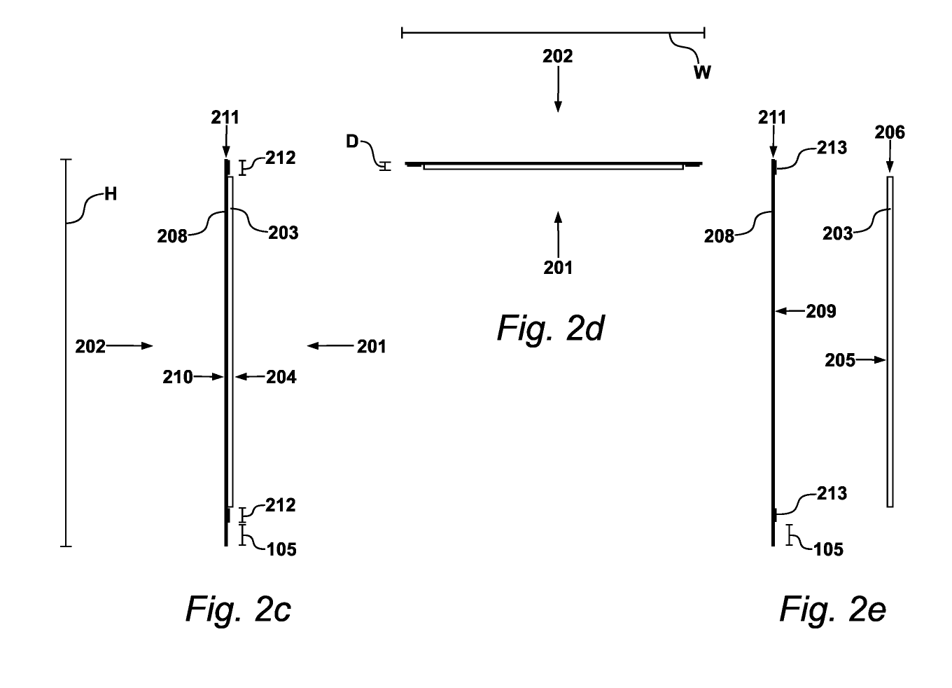

### FIGS. 2a, 2b, 2c, 2d & 2d

Perspiration shield 101 is shown in isolation in FIGS. 2a, 2b, 2c & 2d, in inner and outer plan, side and end elevations respectively. Perspiration shield 101 is shown in an exploded view in FIG. 2e.

Referring to the Figures, in the embodiment said perspiration shield 101 is substantially planar defining an inner side 201 configured to face towards and contact the skin of the underarm when in use, and an opposing outer side 202 configured to face away from the skin when the shield is in use. Said shield 101 comprises a perspiration absorbent material for absorbing perspiration, a perspiration impermeable material for containing the absorbed perspiration and resultant odorous gases, and an adhesive composition for releasably adhering the shield to the skin of the underarm.

It will be understood by the skilled person that a number of different materials are suitable for constructing the shield 101. In a preferred embodiment, said perspiration absorbent material comprises a blend of a semi-synthetic viscose fibre (viscose rayon), and a type of synthetic fibre referred to by the trade mark Super Absorbent Fibre. Of course, it will be appreciated that, in alternative embodiments, other materials capable of absorbing sufficient volumes of perspiration may be used, for example, cotton fibre or paper pulp materials. The primary requirement of said perspiration absorbent material is that it is capable of absorbing volumes of perspiration incident thereon as it might be expected the wearer will excrete from the underarm in a single day. As an example, the preferred perspiration absorbent material has a perspiration absorbency of approximately 30 grams of perspiration per gram of dry absorbent material.

In the specific embodiment, said perspiration impermeable material comprises a polyurethane (PU) polymer material, although again, it will of course be appreciated that alternative materials may be used, for example, other plastic films or metallic foils. Appreciating that no material can ever be considered entirely resistant to the passage of liquid, the perspiration impermeable material selected should ideally substantially prevent the passage of perspiration there-through in the volumes and conditions as might be expected to be experience when the shield is adhered to the wearer's underarm.

In the preferred embodiment, said adhesive composition comprises an acrylic adhesive that is selected to be ‘skin-safe’, i.e. to cause minimal to no skin irritation.

In the specific embodiment, said perspiration absorbent material defines a first layer 203 having an inner side 204 and an outer side 205, and a peripheral edge 206 defining a first shape. In the embodiment, said first layer 203 is generally acute-isosceles triangular in shape and defines a first area 207 of the shield 101, which first area is exposed on the inner side 201 of the shield 101. Exposing the perspiration absorbent material on the inner side 201 of the shield 101, i.e. not covering the perspiration absorbent material with a cover material such as an adhesive composition, advantageously improves its absorption of perspiration.

Further, in the embodiment said perspiration impermeable material defines a second layer 208, distinct from said first layer 203, it having an inner side 209 and an outer side 210, and having a peripheral edge 211 defining a second shape. In the embodiment, said second layer 208 is also generally acute isosceles triangular in shape, and has a relatively larger area than the area of said first layer 203.

Referring to the Figures, in the embodiment said first layer 203 comprising a perspiration absorbent material is arranged on the inner side 209 of said second layer 208, such that the outer side 205 of said first layer 203 is in contact with the inner side 209 of said second layer 208. Preferably the first layer 203 is securely attached to the second layer 208. In the specific embodiment, the first layer 203 is bonded to the second layer by way of a setting adhesive composition applied over substantially the full area of the outer side 205 of the first layer 203.

As previously described, in the specific embodiment said first layer 203 and said second layer 208 are each generally acute-isosceles triangular in shape, said second layer 208 however having a relatively greater area than said first layer 203. Moreover, in the embodiment said first layer 203 and said second layer 208 are relatively oriented such that the bases of each generally acute isosceles triangle layer are substantially mutually aligned, as are the vertexes of each layer. Thus, as illustrated, when said first layer 203 is so arranged with respect to said second layer 208, a border region 212 is defined between the peripheral edge 206 of said first layer 203 and the peripheral edge 211 of said second layer 208. The border region 212 is defined by the inner side 209 of said second layer 208 extending adjacent substantially the full circumference of the second layer 208. In the embodiment, the border region 212 is substantially uniform in width about the circumference of the shield 101. That is to say, the radial distance between the peripheral edge 206 of the first layer 203 and the peripheral edge 211 of the second layer 208 is substantially uniform about the circumference of the shield.

An adhesive composition 213 is disposed on the inner side of said shield 101 about said border region 212 defining an adhesive border 214. The adhesive composition 213 is configured to releasably adhere the shield 101 to the skin of a wearer's underarm. More particularly, the adhesive composition 213 is disposed on the inner side 209 of said second layer 208 proximal the peripheral edge 211 of the second layer 208. In the embodiment, the adhesive composition 213 is disposed over substantially the full area of the border region 212. Thus, in the embodiment, said adhesive border 214 is substantially uniform in width about the circumference of the shield, occupying substantially the full distance between the peripheral edge 206 of the first layer 203 and the peripheral edge 211 of the second layer 208.

Referring to the Figures and in particular FIG. 2a, in the embodiment said adhesive border 214 defines a border extending substantially completely about the circumference of the first area 207 defined by the perspiration absorbent first layer 203, the adhesive border 214 defining a generally triangular annulus extending about the first area 207 without overlapping the first area 207. Moreover, in the embodiment, said adhesive border 214 extends circumferentially about the first area 207 substantially unbroken. That is to say, the adhesive border 214 is substantially continuous about the circumference of the shield 101. One advantage of the adhesive border being unbroken is that perspiration absorbed by the first layer 203 of perspiration absorbent material is contained between the shield 101 and the wearer's skin in the first layer 203, and the perspiration is prevented from leaching outwardly of the shield as might occur if the adhesive border 214 were broken. Moreover, the continuous border of adhesive serves to prevent release of odorant substances resulting from bacterial activity in the perspiration.

Referring particularly to FIGS. 2a and 2b, as previously described, in the embodiment said shield 101 comprises a tab portion 105 configured to facilitate removal of the shield 101 from the skin of the underarm of the wearer. Said tab portion 101 extends radially outwardly of said border region 212 on which said adhesive border 214 is disposed. In the specific embodiment, said tab portion 105 is defined by said second layer 208. Thus, in the embodiment, said tab portion 105 is defined by the peripheral edge 211 of said second layer 208 at a region where the radial distance between the peripheral edge 206 of said first layer 203 and the peripheral edge 211 of said second layer 208 is increased to greater than the average distance between the peripheral edge 206 and the peripheral edge 211.

As illustrated, said tab portion 105 extends outwardly of the natural periphery of the main part of the shield defined by the peripheral edge 211 of the second layer 208. In the embodiment said tab portion 105 extends radially outwardly of the adhesive border 214 adjacent the aligned vertexes of the first and second layers 203, 208, of the shield. That is to say, the tab portion 105 extends outwardly adjacent the torso end 104 of the shield.

In the embodiment, said tab portion 105 is substantially free of said adhesive composition 213. More particularly, in the embodiment the inner (skin-facing) side of said tab portion 105 is free of any adhesive composition. An advantage of the inner side of said tab portion being substantially free of any adhesive is that the tab portion 105 itself will not be adhered to the wearer's skin when the shield is adhered to the skin as described. That the tab portion 105 is substantially free of adhesive on its inner side and so will not adhere to the skin has the advantage that the tab portion 105 can be easily gripped by a wearer to allow removal of the shield from the underarm skin.

In the embodiment the tab portion 105 is shaped and dimensioned so as to be sufficiently large as to allow a wearer to grip the tab portion, but not so large as to substantially reduce the comfort of the shield 101. In the specific embodiment, the tab portion 105 is dimensioned as to conveniently allow a wearer to obtain sufficient purchase on the tab portion between the thumb and forefinger as to exert a force on the tab portion sufficient to break the adhesive bond between the shield 101 and the skin of the wearer's underarm.

In preferred embodiments, said tab portion 105 is significantly smaller than the main part of said shield 101. More particularly, preferably the area of said tab portion 105 is significantly less than said first area 207 defined by said first layer 203 of perspiration absorbent material.

It is preferable however that the tab portion 105 extends outwardly of the adhesive border 214 to a distance that is substantially equal to or greater than the width of said adhesive border 214. That is to say, it is preferable that the tab portion 105 extends outwardly of the adhesive border by a radial distance that is substantially equal to or greater than the radial distance between said peripheral edge 206 and said peripheral edge 211. This relative dimension is advantageous as it would be expected to allow the wearer to obtain sufficient purchase on the tab portion as to overcome the adhesive bond between shield 101 and underarm skin.

In the illustrated embodiment, the height ‘H’ of the shield 101 is approximately 105 millimetre, the width ‘W’ is approximately 80 millimetre, and the depth ‘D’ is approximately 3 millimetre.

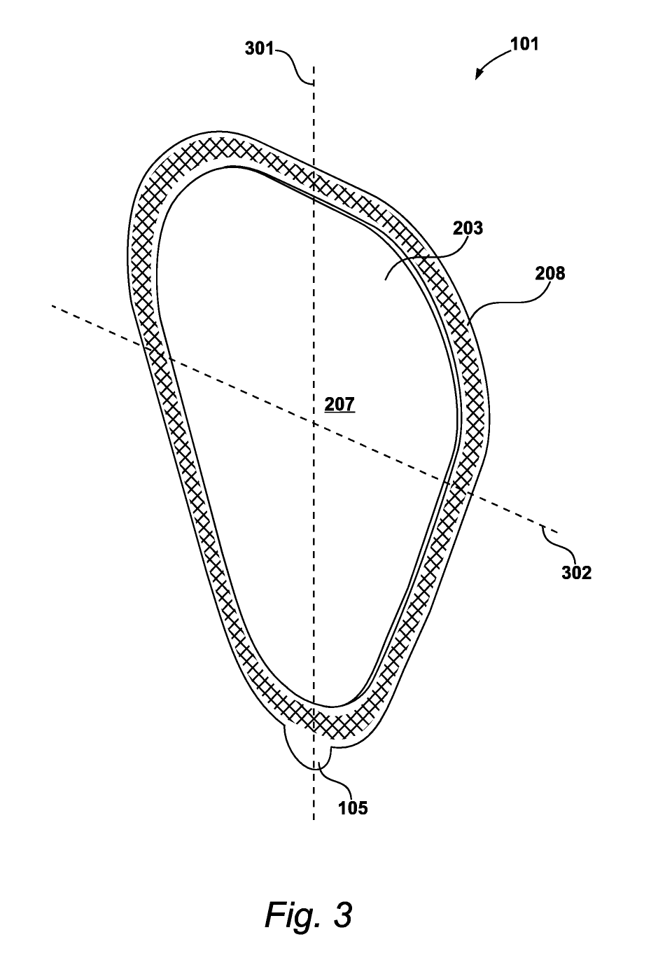

### FIG. 3

Perspiration shield 101 is shown in a perspective view in FIG. 3.

In the embodiment, the perspiration shield 101 is configured to be relatively flexible. Thus, in the embodiment, said first layer 203 of perspiration absorbent material, said second layer 208 of perspiration impermeable material, and said adhesive composition 213 are selected as to be relatively flexible rather than rigid.

In the specific embodiment, the perspiration shield 101 is resiliently biased towards an un-flexed condition in which the perspiration shield is substantially planar (as shown in FIG. 3). The resilient biasing of the perspiration shield towards the planar condition advantageously resists creasing or wrinkling of the shield in use.

However, as noted, in the embodiment the perspiration shield 101 is resiliently flexible away from the planar condition, in order to allow the shield to be flexed to match the contours of a wearer's underarm. Generally, the shield 101 is resiliently flexible at least about a first axis 301, which extends in the height direction H, and about a second axis 302, which extends in the width W direction, substantially orthogonal to axis 301.

Thus, the shield 101 has an inherent degree of flexibility allowing the shield to be readily shaped to conform closely to the shape of a wearer's underarm. Moreover, the flexibility of the materials used in the construction of the shield all it to flex in response to movement by the wearer. The flexibility of the shield 101 thus improves comfort to the wearer.

As described with reference to earlier Figures, preferably said tab portion 105 is significantly smaller in area than the first area 207 defined by said first layer 203. More particularly, it is preferred that the maximum ‘width’ dimension of said tab portion 105 parallel to the axis 302 is significantly smaller than the maximum ‘width’ of said first area 207 along the axis 302. It is preferred that the size of the tab portion 105, and more particularly its width, is relatively lesser than the size and width of the first area 207 in order that the tab portion does not unduly reduce the comfort to the wearer of the shield 101. Preferably then, the area of said tab portion 105 should be minimised as far as practicable, whilst remaining sufficiently large that a wearer may grip the tab portion 105 and exert a sufficient force on the shield 101 as to overcome the adhesive bond between the shield and the wearer's skin.

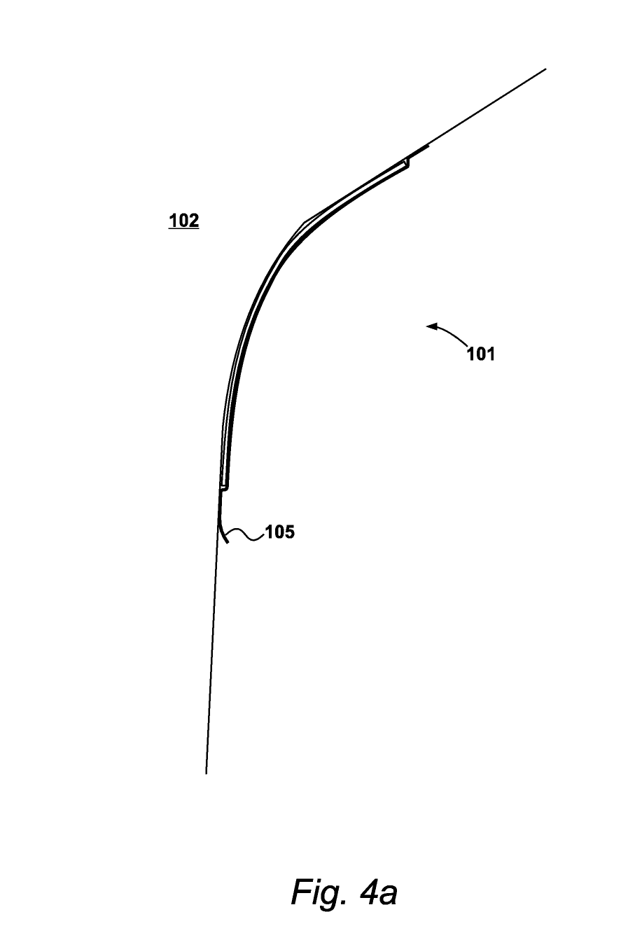

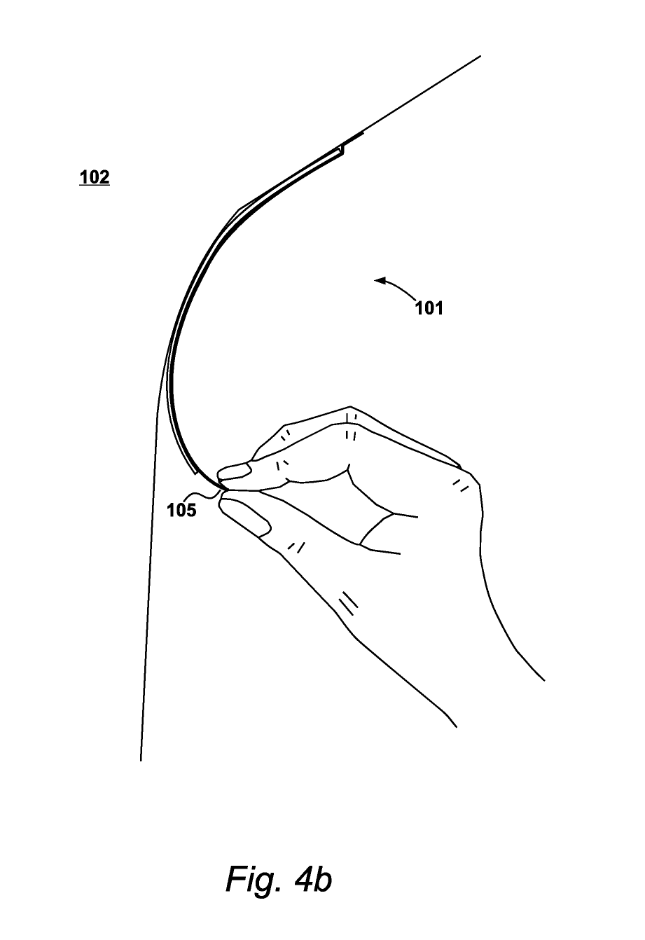

### FIGS. 4a & 4b

Perspiration shield 101 is shown adhered to the underarm skin of the wearer in cross-sectional views in FIGS. 4a and 4b.

Referring to FIG. 4a, perspiration shield 101 is shown fully adhered to the underarm 401 of the wearer 102. Thus, as illustrated, in the fully adhered condition the adhesive border 214 adheres the peripheral edge of the second layer 208 to the skin. Said first layer 203 is thus maintained in close contact with the sweat gland area of the wearer's underarm, with said adhesive border 214 extending generally about the periphery of the sweat gland area. As illustrated, said tab portion 105 remains un-adhered to the skin.

Referring secondly to FIG. 4b, the shield 101 is shown partially removed from the skin. As illustrated, tab portion 105 is configured such that the wearer may grip the tab portion 105 between thumb and forefinger to thereby remove the shield from the skin of the underarm.

In the specific embodiment, the shield 101 is configured to be single-use. Thus, in the embodiment it is expected that the shield 101 will be removed from the skin and disposed of following use.

What we claim is:

1. A perspiration shield releasably adherable to the skin of an underarm and having an inner side and an outer side, the shield comprising:
a perspiration absorbent material;
a perspiration impermeable material; and
an adhesive composition suitable for releasably adhering said shield to the skin of an underarm; in which
said perspiration absorbent material is exposed over at least a portion of said inner side of said shield defining a first area; and
said adhesive composition is disposed on said inner side of said shield defining a border circumferential about said first area; and in which
a portion of said shield extends radially outwardly of said border defining a tab portion.

2. The perspiration shield of claim 1, in which said adhesive border is substantially uniform in width about its circumference.

3. The perspiration shield of claim 1, in which said adhesive border is substantially unbroken about its circumference.

4. The perspiration shield of claim 1, in which said tab portion is substantially free of said adhesive composition.

5. The perspiration shield of claim 1, in which said border is arranged proximal the peripheral edge of said shield.

6. The perspiration shield of claim 1, in which said shield is generally triangular in shape having a base and a vertex.

7. The perspiration shield of claim 1, in which said tab portion extends outwardly from adjacent the vertex of said triangular shaped shield.

8. The perspiration shield of claim 1, in which said perspiration absorbent material defines a first layer having an inner side and an outer side and having a perimeter defining a first shape; and in which said perspiration impermeable material defines a second layer having an inner side and an outer side and having a perimeter defining a second shape.

9. The perspiration shield of claim 8, in which said first layer is arranged on the inner side of said second layer such that said outer side of said first layer contacts said inner side of said second layer.

10. The perspiration shield of claim 8, in which each of said first and second layers are generally triangular in shape.

11. The perspiration shield of claim 8, in which the area of said second layer is relatively greater than the area of said first layer.

12. The perspiration shield of claim 8, in which said border is defined between the perimeter of said first layer and the perimeter of said second layer.

13. The perspiration shield of claim 1, in which said second layer defines said tab portion.

14. The perspiration shield of claim 1, in which said shield is substantially acute-isosceles triangular in shape.

15. The perspiration shield of claim 1, in which said perspiration impermeable material comprises polyurethane.

16. The perspiration shield of claim 1, in which said second layer is fabricated from polyurethane film.

17. The perspiration shield of claim 1, in which said perspiration absorbent material comprises viscose fibre.

18. The perspiration shield of claim 1, in which said tab portion is integral with said second layer.

19. The perspiration shield of claim 1, in which said tab portion is configured to facilitate removal of the shield from the skin of an underarm.

20. The perspiration shield of claim 1 in which said tab portion is dimensioned as to conveniently allow a user to obtain sufficient purchase on the tab portion between the thumb and forefinger as to exert a force on the tab portion sufficient to break the adhesive bond between said shield and the skin of an underarm.
